(19) United States
(12) Patent Application Publication
(10) Pub. No.: US 2002/0131412 A1
(43) Pub. Date: Sep. 19, 2002

(54) Switch fabric with efficient spatial multicast

(76) Inventors: Dipak Shah, San Jose, CA (US); Tzu-Jen Kuo, San Jose, CA (US)

Correspondence Address: BEYER WEAVER & THOMAS LLP, P.O. BOX 778, BERKELEY, CA, 94704-0778, US

(21) Appl. No.: 09/834,964

(22) Filed: Apr. 13, 2001

Related U.S. Application Data
(63) Continuation-in-part of application No. 09/759,434, filed on Jan. 12, 2001.

(51) Int. Cl. H04L 12/28; H04J 3/02

(52) U.S. Cl. 370/390; 370/412; 370/462

(57) ABSTRACT

Efficient techniques for processing multicast requests in a switch system are disclosed. The efficient techniques lead to substantial reduction in switch system bandwidth consumption while processing multicast requests. In one embodiment, a multicast queue is used to hold multicast blocks of data (e.g., cells) that are to be switched, and duplication of the blocks of data for delivery to multiple destinations (e.g., ports) is performed by a switch device (e.g., crossbar switch) as opposed to storage queues or repeated transfers from storage queues to the switch device.

### CROSS REFERENCE TO RELATED APPLICATIONS

This application is a continuation-in-part of U.S. Application No. 09/759,434, filed Jan. 12, 2001, and entitled “SWITCH FABRIC CAPABLE OF AGGREGATING MULTIPLE CHIPS AND LINKS FOR HIGH BANDWIDTH OPERATION”, the content of which is hereby incorporated by reference. This application is also related to U.S. Application No. 09/802,434, filed Mar. 9, 2001, and entitled “SWITCH FABRIC WITH BANDWIDTH EFFICIENT FLOW CONTROL”, the content of which is hereby incorporated by reference.

### BACKGROUND OF THE INVENTION

1. Field of the Invention

The present invention relates to network switching devices and, more particularly, to high bandwidth switching devices.

2. Description of the Related Art

Today's communication markets continue to show strong growth as the bandwidth needed to satisfy the demands of the information age increases. In the carrier markets demand is being driven by the need for bandwidth-hungry data services alongside revenue-generating voice and media traffic.

Multicast is an efficient way of delivering one-to-many communications over networks. With multicast, one stream is sent by a server to the network and a distribution tree forms. Interested recipients are added as a branch to the distribution tree. Routers then replicate packets at each branch of the distribution tree. In this way, no packets are duplicated in the network and the server needs only to send one stream of data. There are two basic approaches to implementing multicast. One approach is referred to as logical multicast and the other approach is referred to as spatial multicast. With logical multicast, a cell pointer is used to reference a single cell in a shared memory. As a result, logical multicast can only support limited bandwidth because it is limited by the access bandwidth to the shared memory.

With spatial multicast, cells are duplicated for each of the virtual channels to be supported. A standard implementation of spatial multicast duplicates multicast cells into corresponding unicast virtual queues such that the cells are thereafter processed as unicast cells. This approach requires duplication of the cells inside a virtual queue manager and thus consumes large amounts of queue resources. A second approach to spatial multicast utilizes a multicast queue within a virtual queue manager to store multicast cells. In either case, one disadvantage of spatial multicast is that multiple requests and multiple cells are transmitted to the switch device. Such multiple transmissions consumes valuable switch bandwidth.

Thus, there is a need for an improved approach to process multicasts such that less switch bandwidth is consumed.

### SUMMARY OF THE INVENTION

Broadly speaking, the invention relates to efficient techniques for processing multicast requests in a switch system. The efficient techniques lead to substantial reduction in switch system bandwidth consumption to process multicast requests. In one embodiment, a multicast queue is used to hold multicast blocks of data (e.g., cells) that are to be switched, and duplication of the blocks of data for delivery to multiple destinations (e.g., ports) is performed by a switch device (e.g., crossbar switch) as opposed to storage queues or repeated transfers from storage queues to the switch device.

The invention can be implemented in numerous ways including, as an apparatus, system, device, method, or a computer readable medium. Several embodiments of the invention are discussed below.

As a switching apparatus, one embodiment of the invention includes: at least one multicast source queue for storing blocks of data, each block including at least a multicast payload; at least one switch operatively connected to the multicast source queue, the at least one switch including at least a scheduler that schedules granting of multicast requests; and a plurality of destination queues operatively connected to the at least one switch. The destination queues receive, via the at least one switch, at least the multicast payload for the multicast requests that that have been granted by the scheduler. When issued to the scheduler, each of the multicast requests operates to request switching the associated multicast payloads through the at least one switch to particular ones of the destination queues. Each of the multicast requests are issued in advance of sending the associated multicast payloads to the at least one switch, and only after a particular multicast request is at least partially granted does the associated multicast payload get transmitted from the associated multicast source queue to the at least one switch.

As a method for multicasting data held in a sending virtual queue through a switching apparatus to receiving virtual queues, one embodiment of the method includes at least the acts of: sending a multicast request from the sending virtual queue to the switching apparatus, the multicast request requesting to transfer a common payload of data to a plurality of the receiving virtual queues; subsequently sending the common payload of data from the sending queue to the switching apparatus after the sending queue receives notification that the multicast request has been at least partially granted; configuring the switching apparatus for the multicast request; and thereafter concurrently transmitting the common payload of data through the configured switching apparatus to a plurality of the receiving virtual queues.

As a method for multicasting data held in a sending virtual queue through a switching apparatus to receiving virtual queues, another embodiment of the method includes at least the acts of: sending a multicast request to the switching apparatus, the multicast request requesting to transfer a common payload of data to a plurality of the receiving virtual queues; scheduling a grant of the multicast request to at least a certain plurality of the receiving virtual queues; saving the grant at the switching apparatus; sending the grant from the switching apparatus to the sending virtual queue; sending the common payload of data from the sending virtual queue to the switching apparatus after the sending virtual queue receives the grant from the switching apparatus; configuring the switching apparatus in accordance with the saved grant; and thereafter concurrently transmitting the common payload data from the switching apparatus to each of the certain plurality of the receiving virtual queues.

As a method for multicasting data held in a sending virtual queue through a switching apparatus to receiving virtual queues, still another embodiment of the method includes at least the acts of: receiving a multicast request to the switching apparatus, the multicast request requesting to transfer a common payload of data from the sending virtual queue to a plurality of the receiving virtual queues; scheduling a grant of the multicast request to at least a certain plurality of the receiving virtual queues; saving the grant at the switching apparatus; and sending the grant from the switching apparatus to the sending virtual queue.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a switch system according to one embodiment of the invention;

FIG. 2 is a block diagram of a switch system according to one embodiment of the invention;

FIG. 3 is a block diagram of a Virtual Queue Manager according to one embodiment of the invention;

FIG. 4 is a block diagram of a Concurrent Switch according to one embodiment of the invention;

FIG. 5 is a diagram illustrating frame-to-cell translation according to one embodiment of the invention;

FIGS. 6A and 6B are flow diagrams of virtual queue manager (VQM) multicast processing according to one embodiment of the invention; and

FIG. 7 is a flow diagram of Concurrent Switch processing according to one embodiment of the invention.

### DETAILED DESCRIPTION OF THE INVENTION

The invention relates to efficient techniques for processing multicast requests in a switch system. The efficient techniques lead to substantial reduction in switch system bandwidth consumption to process multicast requests. In one embodiment, a multicast queue is used to hold multicast blocks of data (e.g., cells) that are to be switched, and duplication of the blocks of data for delivery to multiple destinations (e.g., ports) is performed by a switch device (e.g., crossbar switch) as opposed to storage queues or repeated transfers from storage queues to the switch device.

The switch system according to the invention supports multiple ports. Incoming packets on any of the ports can be switched by the switch system to any of the ports. Further, the incoming packets to a port can be output to one or multiple ports. Unicast refers to the situation where incoming packets to a port are to be output to a single port. Multicast refers to the situation where incoming packets to a port are to be output to multiple ports. Since the invention is directed to the processing of multicast, the following discussion is largely directed to multicast processing, though much is also applicable to unicast and multicast processing.

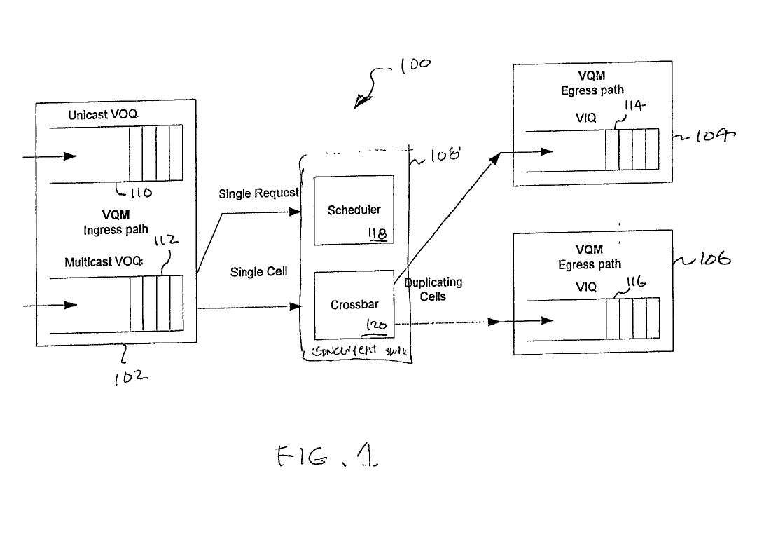

Embodiments of this aspect of the invention are discussed below with reference to FIGS. 1-7. However, those skilled in the art will readily appreciate that the detailed description given herein with respect to these figures is for explanatory purposes as the invention extends beyond these limited embodiments.

FIG. 1 is a block diagram of a switch system 100 according to one embodiment of the invention. The switch system 100 includes a Virtual Queue Manager (VQM) 102 for an ingress path and Virtual Queue Managers (VQMs) 104 and 106 for egress paths. The switch system 100 also includes a concurrent switch 108. Each of the VQMs 102, 104 and 106 includes one or more virtual queues that store blocks of data (e.g., cells) being transmitted to or from the switch system 100. In the embodiment shown in FIG. 1, the VQM 102 includes a plurality of Virtual Output Queues (VOQs). More specifically, the VQM 102 includes a unicast Virtual Output Queue (unicast VOQ) 110 and a multicast Virtual Output Queue (multicast VOQ) 112.

Incoming blocks of data to the switch system 100 can be stored (queued) in either the unicast VOQ 110 or the multicast VOQ 112 depending upon whether the incoming block is a unicast or multicast type of block. A unicast block is destined for a single destination port, while a multicast block is destined for a plurality of destination ports. By providing a separate multicast VOQ 112, the VQM 102 is able to segregate multicast blocks from unicast blocks. Such segregation allows separate processing of these different types of blocks. Typically, multicast blocks are given priority over unicast blocks.

The VQM 104 and the VQM 106 pertain to egress paths and represent two Virtual Queue Managers that can be present on an egress side of the switch system 100. Each of the VQMs 104 and 106 includes one or more Virtual Input Queues (VIQs). In the embodiment of the switch system 100 illustrated in FIG. 1, the VQM 104 includes a VIQ 114 and the VQM 106 includes a VIQ 116.

Although the switch system 100 normally supports both unicast and multicast, since the invention pertains to multicast processing, our discussion below focuses on the request, granting and processing of multicast requests for switching blocks of data through the switch system 100 in a multicast manner. In processing the blocks queued within the multicast VOQ 112, for a given multicast block, a multicast request is transmitted from the VQM 102 to the concurrent switch 108. Specifically, the multicast request is directed to a scheduler 118 within the concurrent switch 108. Upon receiving the request, the scheduler 118 coordinates with other incoming requests from other VOQs (or VQMs) to determine which requests should be granted so that their corresponding blocks of data can be switched through the switch system 100. As a result, the scheduler 118 grants one or more of the incoming requests.

The scheduler 118 then notifies the multicast VOQ 112 that its request has been at least partially granted. The concurrent switch 108 can also store information about the granted multicast request for subsequent use in switching the multicast data. Such grant information can indicate those of the requested destinations (e.g., ports) that are approved to receive the multicast data. After receiving the grant information, the multicast VOQ 112 transmits the block (or cell) of data associated with the multicast request to the concurrent switch 108. Specifically, the block of data (or cell) associated with the multicast request is directed to a crossbar 120 within the concurrent switch 108. The crossbar 120 is a switching device and, for example, is often a crossbar switch. The crossbar 120 is configured in accordance with the grant information so that the crossbar 120 receives the incoming block of data associated with the multicast request and simultaneously directs the block of data to each of a plurality of different VQMs for the egress paths. In this example shown in FIG. 1, it is assumed that the multicast request being processed by the concurrent switch 108 has been granted by the scheduler 118 for simultaneous delivery to the VIQ 114 within the VQM 104 as well as the VIQ 116 within the VQM 106.

As compared to conventional approaches, the switch system 100 according to the invention is able to more efficiently process multicast requests so that the multicast data is passed through the switch system 100 while consuming less of the bandwidth of the switch system 100. The result of the improvement to bandwidth consumption for multicast processing is that data throughput to the switch system 100 is improved while queue capacities need not be enlarged to support such processing.

Hence, it should be noted that a multicast request often only needs to be sent to the concurrent switch 108 once for each multicast request. Additionally, the block of data (cell) associated with the multicast request only needs to be sent to the concurrent switch 108 once for each multicast request. In cases of high levels of congestion or large numbers of destinations for the multicast, a multicast request as well as the block of data (cell) associated with the multicast request may need to be sent more than once. For example, when the scheduler 118 only grants a portion of the requested destinations of the multicast request, then subsequent multicast requests and transfers of the block of data typically would need to be transmitted to the concurrent switch 108.

In general, it should also be noted that a block of data (also know as payload) associated with an earlier multicast request is transmitted to the concurrent switch 108 after the multicast request has been at least partially granted. Consequently, the concurrent switch 108 does not receive the data to be multicast in advance and thus need not contain resources to store (queue) such data for relatively significant periods of time.

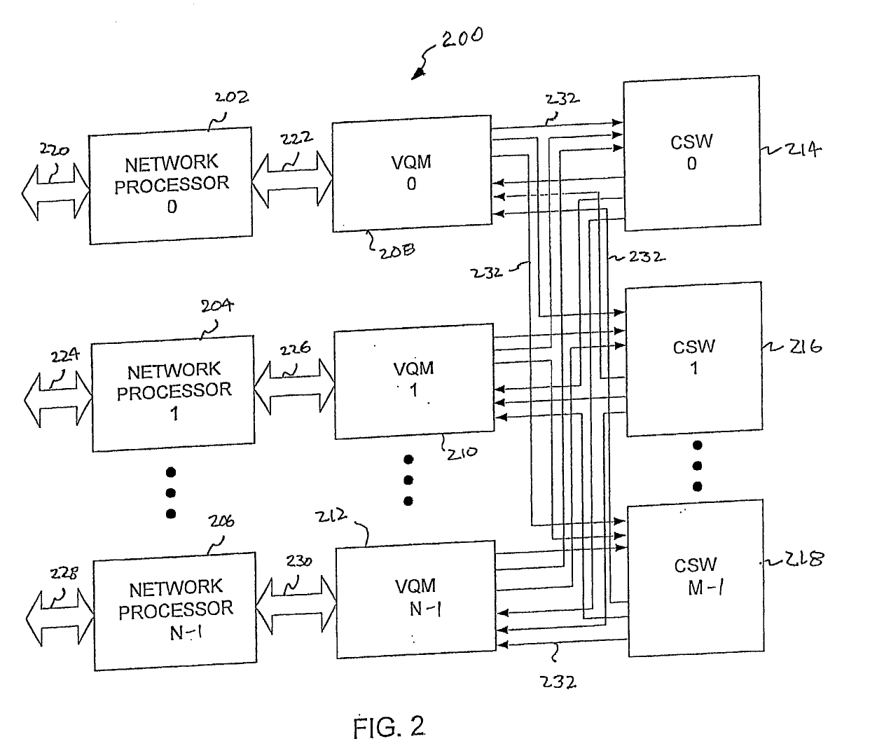

FIG. 2 is a block diagram of a switch system 200 according to one embodiment of the invention. The switch system 200 can implement a switch fabric having multiple different configurations. The switch system 200 can, for example, implement the switch system 100 of FIG. 1 and its multicast processing.

The switch system 200 includes network processors 202, 204 and 206. The network processor 202 couples to a network link through a network interface 220. The network processor 204 couples to a network link through a network interface 224. A network processor 206 couples to a network link through a network interface 228. The network processors 202, 204 and 206 receive packets of data via the corresponding network links and forward the packets to corresponding Virtual Queue Managers (VQMs). The network links in turn couple to one or more networks. The networks can vary widely and can include Local Area Networks, Wide Area Networks, or the Internet.

The Virtual Queue Managers operate to divide each of the packets into a plurality of fixed-length cells (blocks) and then operates to store (queue) the cells. More particularly, the switch system 200 includes Virtual Queue Managers (VQMs) 208, 210 and 212 for storing the cells. Each of the VQMs 208, 210 and 212 respectively correspond to the network processors 202, 204 and 206. The VQM 208 and the network processor 202 communicate over a queue interface 222, the VQM 210 and the network processor 204 communicate over a queue interface 226, and the VQM 212 and the network processor 206 communicate over a queue interface 230.

The VQMs 208, 210 and 212 operate to respectively store (queue) the cells incoming from the network processors 202, 204 and 206 as well as the cells outgoing to the network processors 202, 204 and 206. The switch system 200 also includes Concurrent Switches (CSWs) 214, 216 and 218. The concurrent switches provide the switching element for the switch system 200. In particular, the concurrent switches operate to couple an incoming port to an outgoing port. Specifically, each of the VQMs 208, 210 and 212 couple through links 232 to each of the CSWs 214, 216 and 218. In other words, each of the VQMs receives an incoming link from each of the CSWs 214, 216 and 218 as well as provides an output link 232 to each of the CSWs 214, 216 and 218. In practice, a single bi-directional link can pertain to the incoming link or the outgoing link. The bi-directional link can be parallel or serial, though presently serial is preferred because limitations on available pins.

The switch system 200 operates such that each of the CSWs 214, 216 and 218 is operating to switch in a synchronized manner. The switch system 200 is able to operate in a synchronized manner without having to provide a separate synchronization interface (e.g., lines, connections or links) between the concurrent switches. As will be discussed in more detail below, the switching system 200 includes one or more schedulers that are either external or internal to one or more of the CSWs 214, 216 and 218. In cases where an external scheduler is used, the switch system 200 is also able to operate in a synchronized manner without having to provide a separate synchronization interface (e.g., lines, connections or links) between the concurrent switches and the external scheduler. In either case, the scheduler provided within the switch system 200 sets a schedule that controls which ports or links are utilized to switch data through the CSWs 214, 216 and 218. The synchronized switching by the CSWs 214, 216 and 218 is then in accordance with the schedule.

The switch system 200 includes N network processors, N Virtual Queue Managers (VQMs), and M Concurrent Switches (CSWs). The integer N represents the number of the separate Virtual Queue Managers (VQMs) are used in the system, and the integer M represents the number of the separate Concurrent Switches (CSWs) used in the system. In one embodiment, each of these Virtual Queue Manager (VQM) or Concurrent Switch (CSW) is a separately packaged integrated circuit chip. Typically, the number of pins associated with integrated circuit chips is limited, and thus the maximum number that the integers M and N can take are often limited. The switch system 200 can implement a switch having multiple different configurations.

In accordance with one implementation of the invention, the switch system 200 can easily implement a OC-192 (10 Gbps per port) 32×32 (i.e., 32 ports) switch fabric. In such a configuration, N=32 such that there are thirty-two Virtual Queue Managers (VQMS) and M=8 such that there are eight Concurrent Switches (CSWs). In accordance with another implementation, the switch system 200 can easily implement a OC-768 (40 Gbps per port) 32×32 (i.e., 32 ports) switch fabric. In such a configuration, N=32 such that there are thirty-two Virtual Queue Managers (VQMs) and M=32 such that there are thirty-two Concurrent Switches (CSWs). With today's technology, the concurrent switches typically can only support up to 32 links, and thus the integer N can be limited to 32. However, technology continues to evolve and various companies are currently developing switch chips that are able to support more than 32 links. It is expected that concurrent switches will soon be able to support 64 and 128 links. It is also expected that virtual queue managers will soon be able to support 64 and 128 links. Although the switch system 200 is depicted as having N network processors, N Virtual Queue Managers (VQMs) and M Concurrent Switches (CSWs), it should be note that the number of these respective components need not be the same but could vary.

The switch system 200 can have various different configurations. In one embodiment, each of the concurrent switches includes an internal scheduler that can independently make the switching action determination. In such an embodiment, each scheduler would independently provide the needed switch configuration control for its associated concurrent switch. The schedulers would operate in a synchronized manner such that they each perform a switching action at the same time. In one implementation, the synchronization can be achieved in accordance with a Start of Cell (SoC) field/bit within the cells being switched.

In another embodiment, only one of the concurrent switches includes an internal scheduler that can independently make switching action determinations. In such an embodiment, the CSW 214 can be considered a primary concurrent switch since it includes a scheduler, and the CSWs 216 and 218 can be considered auxiliary concurrent switches since they lack schedulers. The scheduler operates to schedule the switching within each of the concurrent switches (CSWs) 214, 216 and 218. More particularly, each of the Virtual Queue Managers (VQMs) 208, 210 and 212 make requests (via the links 232 coupled to the CSW 214) to the scheduler therein to be able to send cells that they are storing to the CSWs 214, 216 and 218. The scheduler then grants one or more of the requests and so informs the VQMs 208, 210 and 212. Thereafter, based on the grants, one or more of the VQMs 208, 210 and 212 can transfer one or more cells stored therein to one or more of the CSWs 214, 216 and 218.

Each concurrent switch is able to support more links and thus more concurrent switches can be supported (i.e., the depth—the value of the integer N—can be increased). However, since the switching must be synchronized, the scheduler needs to inform at least the remaining CSWs 216 and 218 of the switching action to be performed. The scheduler includes switch control information (e.g., a grant bitmap or a destination identifier) with the grants it returns to the virtual queue managers (e.g., at least VQM 214 and 216). The virtual queue managers can then direct the switch control information to the associated concurrent switches so that the concurrent switches can configure themselves appropriately.

In this embodiment, the remaining CSWs 216 and 218 do not need to include schedulers. However, if the other remaining CSWs 216 and 218 were to include schedulers, such schedulers would normally be inactive or idle. One advantage of having at least one additional scheduler is that its available for back-up should the primary scheduler (e.g., scheduler 252) fail. In other words, the additional schedulers, if provided, provide fault tolerance for the switch system.

In still another embodiment of the invention, the switch system can utilize an external scheduler. In such an embodiment, the scheduler can be a separate integrated circuit chip that couples to each of the VQMs 208, 210 and 212 over the links 232 so as to provide centralized scheduling.

In general, the invention is scalable to support very high bandwidths. The switch system of FIG. 2 can be scaled by increasing the number of virtual queues or concurrent switches. In one embodiment, the switch system 200 illustrated in FIG. 2 can further include one or more banks of Concurrent Switches (CSWs). One or more additional banks can be added to a switch system in this manner to thereby scale the switch system. Each of the CSWs within the additional banks separately couple to the VQMs 208, 210, . . . , 212 through the links 232. Hence, the VQMs need to support more links 232 when additional banks are added. The scaling through different banks can be used alone or in combination with the scaling by increasing the number of virtual queues or concurrent switches.

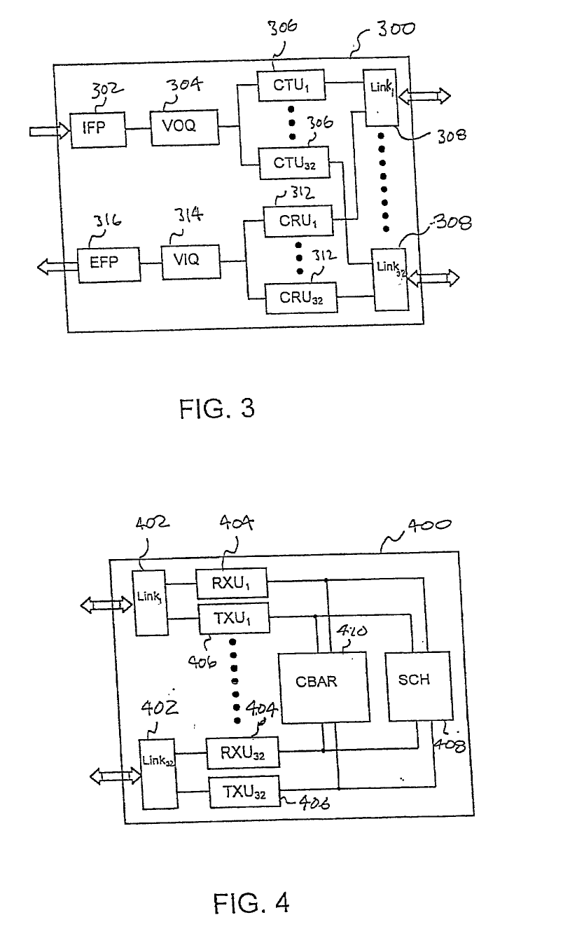

FIG. 3 is a block diagram of a Virtual Queue Manager 300 according to one embodiment of the invention. The Virtual Queue Manager 300 can, for example, represent any of the Virtual Queue Managers (VQMs) 208, 210 and 212 illustrated in FIG. 2.

The Virtual Queue Manager 300 has a transmit side and a receive side. The transmit side receives an incoming packet (frame) from a network processor, divides the packet into cells (blocks) and stores the cells in virtual queue, and thereafter transmits the cells as scheduled to a Concurrent Switches (CSWs) via links. More particularly, the transmit side of the Virtual Queue Manager 300 includes an Ingress Frame Processor (IFP) 302, a Virtual Output Queue (VOQ) 304, and Cell Transmitting Units (CTUs) 306. The Ingress Frame Processor 302 operates to segment incoming frames into cells (blocks). The Virtual Output Queue 304 receives the cells from the Ingress Frame Processor 302 and temporarily stores the cells for eventual transmission. The Cell Transmitting Units 306 operate to transmit cells stored in the Virtual Output Queue 304 over a plurality of links 308 to one or more Concurrent Switches. In the embodiment shown in FIG. 3, the Virtual Queue Manager 300 includes thirty-two (32) bi-directional links. The links 308 couple to Concurrent Switches (CSWs). One or more of the links destined for each Concurrent witch (CSW) can be grouped to represent a port as discussed in more detail below.

The receive side of the Virtual Queue Manager 300 includes Cell Receiving Units (CRUs) 312, a Virtual Input Queue (VIQ) 314, and an Egress Frame Processor (EFP) 316. The links 308 also couple to Cell Receiving Units (CRUs) 312 that receive incoming cells over the links 308 from the Concurrent Switches (CSWs). The incoming cells are then stored in the Virtual Input Queue (VIQ) 314. Then, the Egress Frame Processor (EFP) 316 assembles the cells stored in the VIQ 314 into an outgoing packet (frame) that are directed to a network processor.

Although the Virtual Queue Manager (VQM) 300 illustrated in FIG. 3 indicates a single queue for each transmit and receive side, it should be understood that the number of queues actually or virtually used can vary. For example, each port can be supported by a virtual queue. As another example, each link can be supported by a virtual queue. As another example, multiple queues can be provided to segregate multicast from unicast or segregate different priority levels.

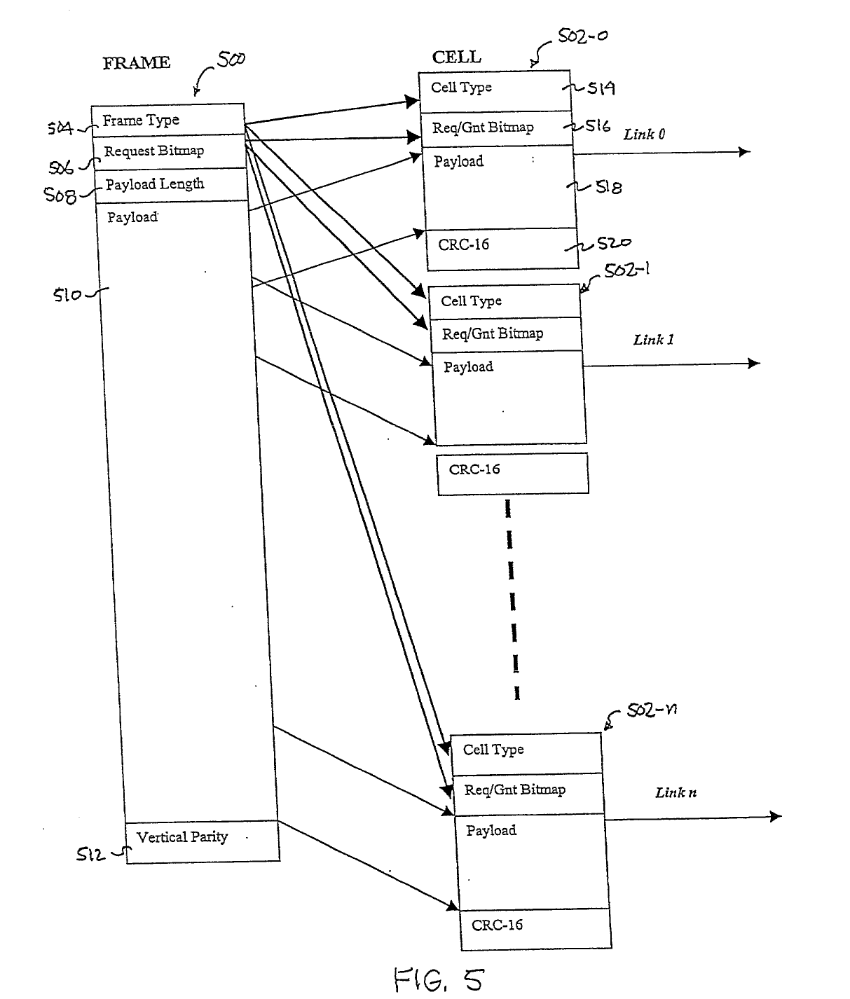

FIG. 4 is a block diagram of a Concurrent Switch 400 according to one embodiment of the invention. The Concurrent switch 400 can, for example, represent the Concurrent switches (CSWs) that include a scheduler. As noted above, other Concurrent Switches can be designed without a scheduler.

The Concurrent Switch 400 includes a plurality of links 402. With respect to the particular embodiment shown in FIG. 4, the Concurrent Switch 400 supports thirty-two (32) bi-directional links. The links 402 typically couple to the links (e.g., links 308) of various Virtual Queue Managers. For each link 402, the Concurrent Switch 400 includes a data receiving unit (RXU) 404 as well as a data transmitting unit (TXU) 406. When receiving a cell (block) over one or more of the links 402, one or more of the data receiving units 404 directs a header portion of the cell to a scheduler (SCH) 408 and directs a payload portion (payload and payload header) to a crossbar (CBAR) 410. The header portion directed to the scheduler 408 may include a request from an associated Virtual Queue Manager. Hence, the scheduler 408 may produce a grant to one or more incoming requests. The crossbar 410 is configured in accordance with grant information previously stored in the Concurrent Switch 400 (for multicast) or in accordance with destination or configuration information supplied within the payload portion (for unicast). The output of the crossbar 410 is the switched payload. Then, one or more of the data transmitting units 406 form a cell having a header portion provided by the scheduler 408 and a payload portion provided by the crossbar 410. Here, the header portion can include a grant in response to the one or more incoming requests.

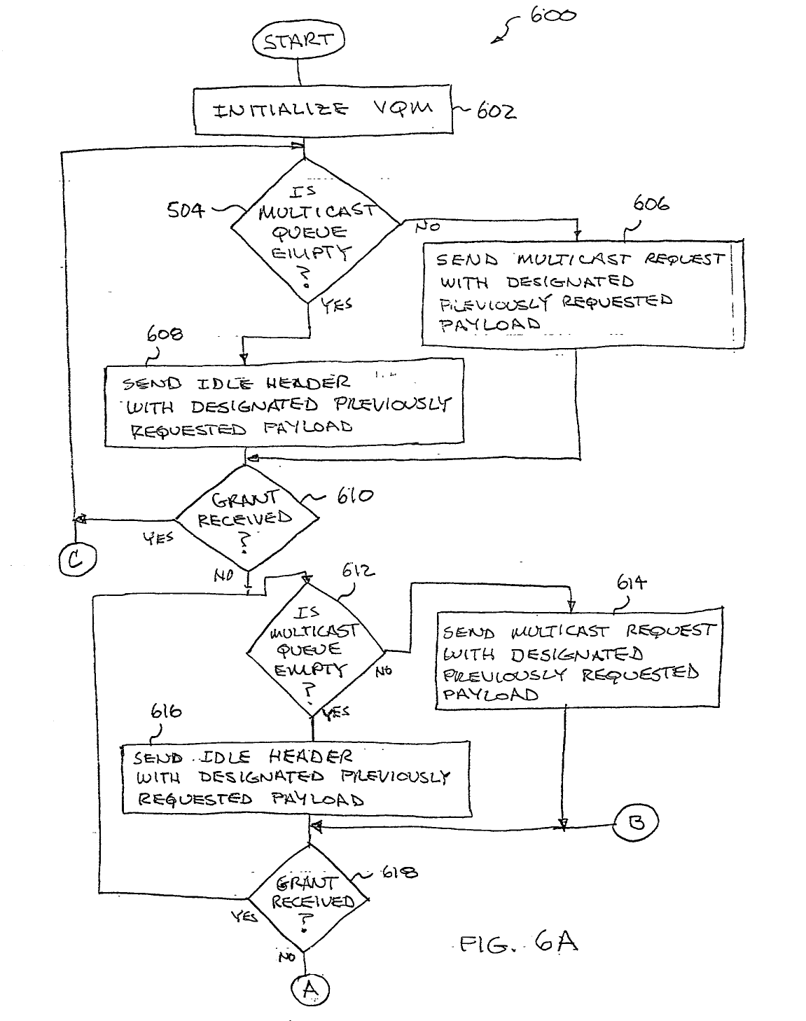

FIG. 5 is a diagram illustrating frame-to-cell translation according to one embodiment of the invention. An incoming frame 500 is converted into a plurality of cells 502 (502-0, . . . , 502-n). The size of the cells is fixed but can, if desired, vary as the frame size varies. In one embodiment, a virtual queue manager, such as the virtual queue manager 300 illustrated in FIG. 3, can perform the frame-to-cell translation. The cells can also be referred to as blocks, as one or more blocks can represent a cell.

The frame 500 includes a frame type 504, a request bitmap 506, a payload length 508, a payload 510, and a vertical parity 512. The frame type 504 and the request bitmap 506 form a header. The cells 502 each include a cell control header (CCH) that includes primarily a cell type 514 and a request/grant bitmap 516. The cells also each include a payload 518 and a cyclic redundancy check (CRC) 520. The frame-to-cell translation forms the CCH from the header of the frame 500, and forms the CRC from the vertical parity 512, and further forms the payload 518 for the cell 502 from the payload 510 of the frame 500. The frame-to-cell translation can be performed without adding any overhead.

A representative CCH is described below in Tables I and II. The representative CCH in Table I pertains to the CCH used from a virtual queue manager to a concurrent switch, and the representative CCH in Table II pertains to the CCH used from a concurrent switch to a virtual queue manager.

TABLE I
CCH (VQM to CSWs)

| Field | |
|---|---|
| Name | Description |
| Ctype | 00 = Idle, 01 = Unicast Request, 10 = Multicast Request, |
| | 11 = Backpressure |
| Class | QoS class or Request priority |
| Bitmap | Request bitmap from VOQ (one bit per port/queue) |
| SOF | Start-of-Frame (associated with payload) |
| Main | Main/Aux. link |

TABLE II
CCH (CSWs to VQM)

| Field | |
|---|---|
| Name | Description |
| Ctype | 00 = Idle, 01 = Unicast Grant, 10 = Multicast Grant, |
| | 11 = reserved |
| Class | QoS class or Request priority |
| Bitmap | Grant bitmap for VOQ (one bit per port/queue) |
| SOF | Start-of-Frame (associated with payload) |
| Main | Main/Aux. link |

As noted above, the cell format can have different formats. In particular, the cells can use either a primary (main) format or an auxiliary format. The primary format has a larger header so that requests/grants can be exchanged. On the other hand, the auxiliary format is able to carry a greater payload since the size of the header is reduced with this format.

Table III provides representative cell format that can be used on the interface between a virtual queue manager and concurrent switch.

TABLE III
Cell Format

| Field Name | Description |
|---|---|
| SOC | Start-Of-Cell |
| CCH | Cell Control Header (see Table I or II) |
| CRC | Cyclic Redundancy Check |
| CPD | Payload Header |
| CPL | Cell Payload |

As a representative example, Start Of Cell (SOC) use 1 bit per clock, Cell Control Header (CCH) is 16 bits (plus 32-bit request/grant bitmap if it is primary block), Cyclic Redundancy Check (CRC) uses 16 bits, and the payload header (CPD) is 5 bits (which can support up to 32 ports). In general, the request bitmap is used to make switching requests to a scheduler, and the grant bitmap is used to return an indication of the granting of requests to virtual queues. In one implementation, as here, request and grants are conveyed with bitmaps where each bit in a bitmap can represent a different port. The payload header (CPD) identifies the destination for the payload as granted by a scheduler. The payload header (CPD) is used to configure a concurrent switch to perform a particular switching operation. In the representative example, the cell/block size is 36 bytes (9 bits over 32 cycles) per link excluding SOC bit. Hence, the primary block contains 6 bytes CCH (with bitmap), 2 bytes CRC, 28 bytes cell payload (CPL) (including CPD). Alternatively, the auxiliary block contains 2 bytes CCH (without bitmap), 2 bytes CRC, 32 bytes cell payload (CPL) (including CPD). The auxiliary block format does not need the request/grant bitmap for scheduler, hence it saves 4 bytes for payload.

Further, it is assumed that each cell is transferred within K clock cycles, integer K is the number of cycles that scheduler can finish payload scheduling, and transfer control header with enough payload between a virtual queue manager and a concurrent switch. In one embodiment, K=32, though various other arrangements can be used.

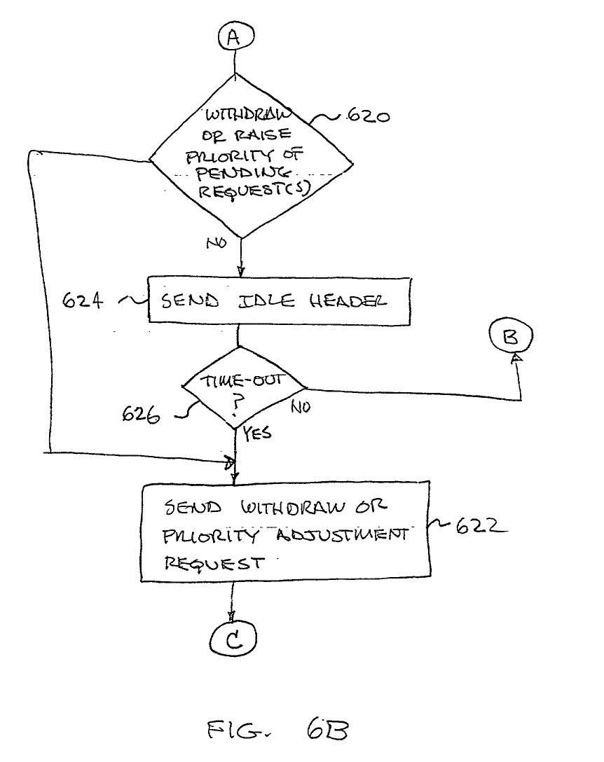

FIGS. 6A and 6B are flow diagrams of virtual queue manager (VQM) multicast processing 600 according to one embodiment of the invention. The VQM multicast processing 600 is, for example, performed by a virtual queue manager, such as the virtual queue manager 102 illustrated in FIG. 1 or the virtual queue manager 300 illustrated in FIG. 3. Typically, the virtual queue manager provides at least one unicast output queue, at least one multicast output queue, at least one input unicast queue, and at least one input multicast queue. Here, the VQM multicast processing 600 is directed to processing associated with the output multicast queue. VQM processing for the output unicast queue is described in U.S. Application No. 09/759,434, filed Jan. 12, 2001, and entitled “SWITCH FABRIC CAPABLE OF AGGREGATING MULTIPLE CHIPS AND LINKS FOR HIGH BANDWIDTH OPERATION”, the content of which is hereby incorporated by reference.

The VQM multicast processing 600 initially initializes 602 a virtual queue manager (VQM). Then, a decision 604 determines whether an output multicast queue is empty. For example, with respect to FIG. 3, the decision 604 determines whether a multicast queue in the Virtual Output Queue (VOQ) 304 is empty (i.e., whether any multicast requests to be processed are in the multicast queue). When the decision 604 determines that the multicast queue is not empty, then a multicast request together with a designated previously requested payload is sent 606. On the other hand, when the decision 604 determines that the multicast queue is empty, then an idle header with a designated previously requested payload is instead sent 608. Following the operations 606 or 608, a decision 610 determines whether a grant (multicast grant) has been received at the virtual queue manager. When a grant (multicast grant) is received, the grant is received by an output multicast queue. A grant (multicast grant) is associated with a prior multicast request and represents an indication of the extent to which the prior multicast request is permitted. In other words, a grant serves to designate previously requested payload for transmission (e.g., to switch). For example, with respect to FIG. 3, the Cell Receiving Unit (CRU) 312 can receive the grant and direct it to the Virtual Output Queue (VOQ) 304. Further, any payload(s) being received by the Virtual Queue Manager (VQM) are received by an input queue. The received payload at the input queue (e.g., VIQ 314) is stored (queued) according to the payload header (e.g., cell payload source ID). For example, with respect to FIG. 3, the payload(s) can be received by one or more of the Cell Receiving Units (CRUs) 312 and then stored to the Virtual Input Queue (VIQ) 314.

When the decision 610 determines that a grant (multicast grant) has been received, then the VQM processing 600 designates its requested payload (i.e., payload associated with the multicast request that has been granted) for transmission and returns to repeat the decision 604 and subsequent operations so that additional requests and/or payloads can be sent (i.e., operations 606 and 608). For example, with respect to FIG. 3, the VOQ 304 receives a grant and puts its requested payload (e.g., cell or blocks) out to one or more of the Cell Transmitting Units (CTUs) 306 for transmission.

Alternatively, when the decision 610 determines that a grant has not been received, then a decision 612 determines whether the output multicast queue is empty. When the decision 612 determines that the multicast queue is not empty, then a multicast request together with a designated previously requested payload is sent 614. On the other hand, when the decision 612 determines that the queue is empty, then an idle header with a designated previously requested payload is instead sent 616. Following the operations 614 or 616, a decision 618 determines whether a grant has been received at the virtual queue manager. As noted above, a grant serves to designate previously requested payload for transmission (e.g., to switch). When a grant is received, the grant is received by the output queue. Further, any payload(s) being received by the Virtual Queue Manager (VQM) are received by the input queue. The received payload at the input queue is stored (queued) according to the payload header (e.g., cell payload source ID). When the decision 618 determines that a grant has been received, then the VQM processing 600 designates its requested payload (i.e., payload associated with the request that has been granted) for transmission and returns to repeat the decision 612 and subsequent operations so that additional multicast requests and/or payloads can be sent (i.e., operations 614 and 616).

Alternatively, when the decision 618 determines that a grant has not been received, then a decision 620 determines whether the pending requests should be withdrawn (eliminated) or have their priority raised. The granting of requests are controlled by a scheduler that arbitrates amongst a plurality of incoming requests associated with the various ports and decides which one or more of the requests to grant. The arbitration typically takes priority levels into consideration, whereby multicast requests are given priority over unicast requests. When the decision 620 determines that one or more of the pending requests should be withdrawn or have their priority raised, then a withdraw or priority adjustment request is sent 622 by the VQM multicast processing 600. Following the operation 622, the VQM processing 600 returns to repeat the decision 604 and subsequent operations.

On the other hand, when the decision 620 determines that the pending requests are to be withdrawn or have their priority raised, then an idle header is sent 624. Here, there are already two (2) pending requests waiting to be granted, so additional requests are not sent (even if were available in the output queue). Instead, an idle header is sent in place of a request. The idle header indicates to the scheduler that the corresponding port presently has no more requests for data transfer.

Next, a decision 626 determines whether a time-out has occurred. The time-out represents a limit on the amount of time to wait for a grant to be received. When the decision 626 determines that a time-out has not yet occurred, then the VQM multicast processing 600 returns to repeat the decision 618. On the other hand, when the decision 626 determines that the idle condition has timed-out, then the VQM multicast processing 600 returns to repeat the decision 604 via the operation 622. In one embodiment, each request can have its own time-out timer.

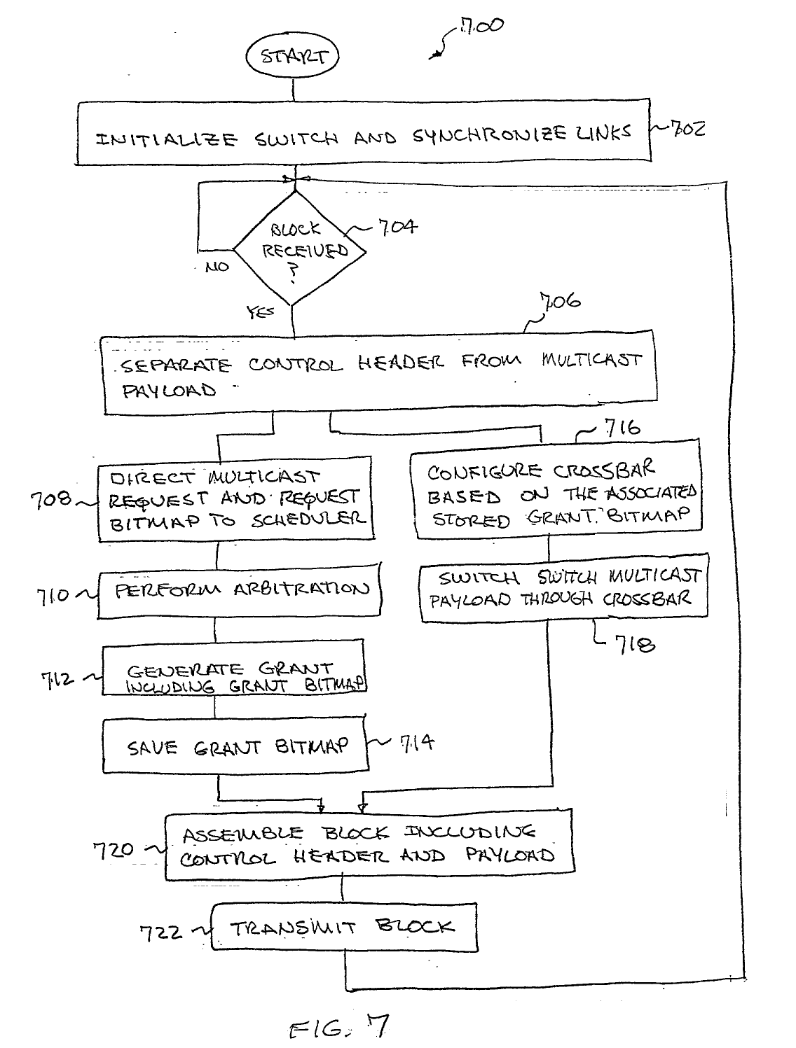

FIG. 7 is a flow diagram of Concurrent Switch processing 700 according to one embodiment of the invention. The switch processing 700 is for example, performed by a switch, such as the concurrent switch 400 illustrated in FIG. 4.

The switch processing 700 initializes 702 the switch and synchronizes its links. Next, a decision 704 determines whether a block has been received on an incoming port (source port). For example, in the case of the concurrent switch 400 illustrated in FIG. 4, the block can be received at a receiving unit (RXU). When the decision 704 determines that a block is not yet been received, then the switch processing 700 awaits reception of such a block.

Once the decision 704 determines that a block has been received, then the block is processed as follows. A block includes a control header and a payload. The control header is, for example, the Cell control Header (CCH) described above. The payload is the data that is to be transported through the switch. Since the switching processing 700 is directed primarily to multicast blocks, the payload is a multicast payload. Once a block has been received, the control header is separated 706 from the multicast payload and its payload header (e.g., including a multicast identifier) that forms part of the payload. The payload header, or control header, includes at least a multicast request and a request bitmap. The multicast request and the request bitmap are directed 708 to a scheduler associated with the switch. The scheduler, for example, can be the scheduler 410 illustrated in FIG. 4. Arbitration is then performed 710 to determine which of various requests that have been received should be granted. The arbitration is typically performed by the scheduler. Following the arbitration, a grant is generated 712. The grant is the grant of a request, and the grant includes a grant bitmap. With the grant of a multicast request, the grant bitmap indicates each of the plurality of requested destinations authorized to receive the payload. The grant bitmap is also saved 714 at the concurrent switch 400 for subsequent use in configuring the switch for multicast delivery.

While operations 708-714 are being performed, a crossbar (more generally, switch) is configured 716 based on the stored grant bitmap associated with the multicast payload being switched. The grant bitmap associated with the multicast payload was previously stored (saved) 714 when the multicast request was granted. For example, the crossbar can be the crossbar 408 illustrated in FIG. 4. Once configured 716, the crossbar is able to deliver the multicast payload simultaneously to multiple input queues. After the crossbar has been configured 716, the multicast payload is switched 718 through the crossbar. The previously stored grant bitmap can thereafter be discarded.

Following operations 714 and 716, an outgoing block is assembled 720. The outgoing block includes a control header and payload. Then, the block is transmitted 722 to multiple outgoing ports (destination ports). For example, in the case of the concurrent switch 400 illustrated in FIG. 4, the block can be transmitted at a transmission unit (TXU) to multiple receiving units (RXUS) of different Virtual Queue Managers (VQMs).

Although the switch processing 700 is largely described with respect to processing of a single block provided over a single link, the switch can also simultaneously process a plurality of blocks received over different links provided no conflicts within the crossbar and provided different output links are used.

Table IV, provided below, contains a simplified example of a protocol used to switch multicast data through a switch system according to one example of the invention. The protocol uses multiple cycles to switch data through the switch system. The cycles 1, 2, . . . 7 represent a series of cycles performed by the switch system. The switch system includes a source Virtual Queue Manager (VQMsrc), a concurrent switch (CSW), and a destination Virtual Queue Manager (VQMdest). The source VQM, at cycle 1, stores a multicast cell into a multicast virtual queue (e.g., multicast VOQ 112). Next, in cycle 2, a multicast request (including a multicast bitmap) is transmitted to the CSW. In cycle 3, a scheduler within the CSW then decides to grant the multicast request. In cycle 4, the CSW transmits a multicast grant (together with a grant bitmap) back to the source VQM. Additionally, at cycle 4, the CSW saves the grant bitmap associated with the multicast grant. Subsequently, in cycle 5, the source VQM transmits the data (cell) from the multicast VOQ to the CSW. The CSW also continues to store the grant bitmap associated with the multicast grant. In cycle 6, the CSW uses the saved grant bitmap to configure the crossbar associated with the CSW. In configuring the crossbar, cell duplication inherently occurs as the cell is to be delivered to multiple destination ports. In cycle 7, the destination VQMs (VQMs associated with the multiple destinations) receive the data (cell) that has been passed through the CSW. The grant information utilized in cycle 6 can then also be discarded in cycle 7.

TABLE IV

| Cycle | VQM(src) | CSW | VQM(dest) |
|---|---|---|---|
| Cycle 1 | Multicast Cell | | |
| | stored into | | |
| | Multicast | | |
| | Virtual | | |
| | Queue | | |
| Cycle 2 | Multicast | | |
| | Request | | |
| | (with | | |
| | Multicast | | |
| | Bitmap) sent | | |
| | to CSW | | |
| Cycle 3 | | Scheduler | |
| | | grants | |
| | | Multicast | |
| | | Request | |
| Cycle 4 | Multicast | Save Grant | |
| | Grant (with | Bitmap | |
| | Grant | | |
| | Bitmap) | | |
| | received from | | |
| | CSW | | |
| Cycle 5 | Transmit Cell | | |
| | from | | |
| | Multicast | | |
| | Virtual | | |
| | Queue to | | |
| | CSW | | |
| Cycle 6 | | Configure | |
| | | Csw | |
| | | (crossbar) | |
| | | with saved | |
| | | Grant Bitmap | |
| | | Duplicating | |
| | | Cell for | |
| | | Destination | |
| | | Ports | |
| Cycle 7 | | | Receive Cell |
| | | | at Multiple |
| | | | Destination |
| | | | VQMs (virtual |
| | | | queues) |
| | | | (ports) |

The switch, switching apparatus or switch system can represented a variety of devices or apparatuses. Examples of such devices or apparatuses include: switches, routers, bridges, gateways, etc.

The invention is preferably implemented in hardware, but can be implemented in a combination of hardware and software. Such software can also be embodied as computer readable code on a computer readable medium. Examples of computer readable code includes program instructions, such as machine code (e.g., produced by a compiler) or files containing higher level code that may be executed by a computer using an interpreter or other means. The computer readable medium is any data storage device that can store data which can be thereafter be read by a computer system. Examples of the computer readable medium include read-only memory, random-access memory, CD-ROMs, magnetic tape, optical data storage devices, or carrier waves. In the case of carrier waves, the invention can be embodied in a carrier wave travelling over an appropriate medium such as airwaves, optical lines, electric lines, etc. The computer readable medium can also be distributed over a network coupled computer systems so that the computer readable code is stored and executed in a distributed fashion.

The advantages of the invention are numerous. Different embodiments or implementations may yield one or more of the following advantages. One advantage of the invention is that switching of multicast blocks of data through a switch can be performed with substantially improved bandwidth efficiency. Another advantage of the invention is that duplication of the blocks of data for the various destinations occurs in a switch device without need for performing duplication of the blocks of data at queuing resources. Still another advantage of the invention is that blocks of data to be multicast are provided to a switch device only after a request for switching the multicast has been granted.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A switching apparatus, comprising:
at least one multicast source queue for storing blocks of data, each block including at least a multicast payload;
at least one switch operatively connected to said multicast source queue, said at least one switch including at least a scheduler that schedules granting of multicast requests; and
a plurality of destination queues operatively connected to said at least one switch, said destination queues receiving, via said at least one switch, at least the multicast payload for the multicast requests that that have been granted by said scheduler,
wherein, when issued to the scheduler, each of the multicast requests operates to request switching the associated multicast payloads through said at least one switch to particular ones of said destination queues, and
wherein each of the multicast requests are issued in advance of sending the associated multicast payloads to said at least one switch, and only after a particular multicast request is at least partially granted does the associated multicast payload get transmitted from the associated multicast source queue to said at least one switch.

2. A switching apparatus as recited in claim 1, wherein said at least one switch simultaneously delivers the associated multicast payload to a plurality of said destination queues.

3. A switching apparatus as recited in claim 1, wherein when the particular multicast request is at least partially granted by said scheduler, a grant is provided to the associated multicast source queue.

4. A switching apparatus as recited in claim 3, wherein the grant indicates a set of said destination queues that are scheduled to simultaneously receive the associated multicast payload.

5. A switching apparatus as recited in claim 4, wherein the grant is temporarily stored at said at least one switch for subsequent use in configuring said at least one switch to deliver the associated multicast payload to the set of said destination queues.

6. A switching apparatus as recited in claim 1, wherein the associated multicast payload is sent to said at least one switch from the associated multicast source queue only once for each of the multicast requests that have been granted, yet is simultaneously delivered to a plurality of said destination queues.

7. A switching apparatus as recited in claim 1, wherein said multicast source queue is a virtual queue, and wherein said destination queues are virtual queues.

8. A method for multicasting data held in a sending virtual queue through a switching apparatus to receiving virtual queues, said method comprising:
sending a multicast request from the sending virtual queue to the switching apparatus, the multicast request requesting to transfer a common payload of data to a plurality of the receiving virtual queues;
subsequently sending the common payload of data from the sending queue to the switching apparatus after the sending queue receives notification that the multicast request has been at least partially granted;
configuring the switching apparatus for the multicast request; and
thereafter concurrently transmitting the common payload of data through the configured switching apparatus to a plurality of the receiving virtual queues.

9. A method as recited in claim 8, wherein a grant is produced when the multicast request has been at least partially granted, and
wherein said configuring of the switching apparatus is in accordance with the grant.

10. A method as recited in claim 8, wherein said sending operates to send the multicast request to the switching apparatus only once and to send the common payload of data from the sending queue to the switching apparatus only once, unless the multicast request is initially not completely granted.

11. A method as recited in claim 8,
wherein the multicast request requests to transfer the common payload of data to N of the receiving virtual queues, where N is an integer, and
wherein said sending operates to send the multicast request from the sending virtual queue to the switching apparatus substantially less than N times and to send the common payload of data from the sending virtual queue to the switching apparatus less than N times.

12. A method as recited in claim 8, whereby the common payload data is sent to the switching apparatus after the associated multicast request has been at least partially granted such that the switching apparatus need not store the common payload data while awaiting at least partial granting of the multicast request.

13. A method for multicasting data held in a sending virtual queue through a switching apparatus to receiving virtual queues, said method comprising:
sending a multicast request to the switching apparatus, the multicast request requesting to transfer a common payload of data to a plurality of the receiving virtual queues;
scheduling a grant of the multicast request to at least a certain plurality of the receiving virtual queues;
saving the grant at the switching apparatus;
sending the grant from the switching apparatus to the sending virtual queue;
sending the common payload of data from the sending virtual queue to the switching apparatus after the sending virtual queue receives the grant from the switching apparatus;
configuring the switching apparatus in accordance with the saved grant; and
thereafter concurrently transmitting the common payload data from the switching apparatus to each of the certain plurality of the receiving virtual queues.

14. A method as recited in claim 13, wherein duplication of the payload data occurs in the switching apparatus.

15. A method as recited in claim 13, wherein said configuring occurs when the switching apparatus receives the common payload data.

16. A method as recited in claim 13, wherein only a single multicast request is required to send the common payload data to the certain plurality of the receiving virtual queues.

17. A method as recited in claim 13, wherein the switching apparatus comprises a scheduler and a switching device.

18. A method as recited in claim 13, wherein, for the multicast request, the common payload data is sent only once from the sending queue to the switching apparatus.

19. A method as recited in claim 13, wherein, more than half the time, a given multicast request is sent only once from the sending virtual queue to the switching apparatus.

20. A method as recited in claim 13,
wherein the multicast request serves to send the common payload data to N of the receiving virtual queues, where N is an integer, and
wherein, on average, a given multicast request is sent substantially less than N times from the sending virtual queue to the switching apparatus.

21. A method as recited in claim 13, wherein the grant includes a grant bitmap, and
wherein said sending of the common payload of data from the sending queue to the switching apparatus operates in accordance with the grant bitmap.

22. A method for multicasting data held in a sending virtual queue through a switching apparatus to receiving virtual queues, said method comprising:
receiving a multicast request to the switching apparatus, the multicast request requesting to transfer a common payload of data from the sending virtual queue to a plurality of the receiving virtual queues;
scheduling a grant of the multicast request to at least a certain plurality of the receiving virtual queues;
saving the grant at the switching apparatus; and
sending the grant from the switching apparatus to the sending virtual queue.

23. A method as recited in claim 22, wherein said method further comprises:
receiving the common payload of data at the switching apparatus from the sending virtual queue;
configuring the switching apparatus in accordance with the saved grant; and
thereafter concurrently transmitting the common payload data from the switching apparatus to each of the certain plurality of the receiving virtual queues.

24. A method as recited in claim 23, wherein said method further comprises:
discarding the saved grant following during or after said transmitting of the common payload data.

25. A method as recited in claim 23, wherein the saved grant comprises a grant bitmap.
